(19) United States
(12) Patent Application Publication
(10) Pub. No.: US 2003/0234145 A1
(43) Pub. Date: Dec. 25, 2003

(54) Rotary damper device

(75) Inventor: Hiroyuki Iwashita, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/349,157

(22) Filed: Jan. 21, 2003

(30) Foreign Application Priority Data
Jan. 23, 2002 (JP) 2002-014152

(51) Int. Cl. F16D 57/00

(52) U.S. Cl. 188/290

(57) ABSTRACT

A rotary damper device includes a case, a rotor member relatively rotatably supported by the case, a rotation vane formed protruded from the rotor member, and a check valve mounted on the rotation vane. The case is provided with an opened part on one side through which the rotor member is inserted into the inside of the case and a side wall part on the other side for rotatably supporting the rotor member. The opened part of the case is closed by a flange part that is integrally formed in the rotor member, and the side wall part includes a pressure receiving face and the flange part includes another pressure receiving face.

### BACKGROUND OF THE INVENTION

1. Field of the Invention

The present invention relates to a rotary damper device, which can be applied to a rotary device such as a rotary cover or a rotary door opening or closing with a hinge. More particularly, the present invention relates to a damper device preferably applied to a hinge mechanism of a toilet seat/seat lid, which regulates the rotating speed in one direction.

2. Description of Related Art

A conventional damper device 100 is generally shown in FIGS. 8(a) and 8(b). FIG. 8(a) shows a cross-sectional view perpendicular to a rotation axis C and FIG. 8(b) shows a longitudinal sectional view along the rotation axis C.

The damper device 100 is mounted, for example, to a toilet seat hinge of a Western style toilet stool (not shown). In FIG. 8(a), when the toilet seat/seat lid is moved in an open direction from the closed position, a rotor member 101 rotates in a counterclockwise direction. A check valve 102 attached on the rotor member 101 releases a closed state with a rotation vane 103 due to oil resistance by the rotation of the rotor member 101 in the counterclockwise direction (see right-half section in FIG. 8(a)). Since an orifice 104 formed in the rotation vane 103 is opened so that oil can move with little resistance, the toilet seat/seat lid can be opened with little force.

When the toilet seat/seat lid is moved in a closed direction (clockwise direction in FIG. 8(a)) from the fully opened position, the rotor member 101 rotates with the toilet seat hinge. The movement of the rotor member 101 makes the check valve 102 attached on the rotor member 101 tightly come in contact with the rotation vane 103 of the rotor member 101 due to the oil resistance (see left-half section in FIG. 8(a)). The rotation vane 103 is provided with the orifice 104 and the orifice 104 is closed with the check valve 102, which is tightly in contact with the rotation vane 103. The flow of oil is restricted to make the toilet seat/seat lid close slowly by the oil resistance.

The damper device 100 is constituted, as shown in FIG. 8(b), in such a manner that the rotor member 101 mounted with the check valve 102 is inserted into a case 105, which is a cylindrical member. The damper device 100 also includes a cover 106 sealed and fixed to the case 105 by screws, supersonic wave welding or the like so as not to leak the oil out after the oil is filled into the case 105.

However, even though the case 105 and the cover 106 are fixed to each other by screws, supersonic wave welding or the like, the problem of oil leakage is not still solved. That is because the force due to the oil pressure in the case 105 is applied in the direction so as to try to separate the cover 106 from the case 105.

In addition, when the cover 106 is used, the shaft diameter of the rotor member is restricted by the cover 106, which gives restrictions on the counterpart member to which the damper device is mounted and thus the scopes and fields of application for the damper device may be limited. Also, when the case is made of metal so as to miniaturize the damper device and also bear the internal-pressure of oil, the supersonic wave welding, which is superior to sealing, can not be used to fix the case 105 and the cover 106 together. Therefore, in this case, it is difficult to obtain the small-sized oil damper device having a strong damping effect.

A damper device in which a rotor shaft is inserted into a case and a screw for fixing the rotor shaft is known in the prior art. However, this is a damper device, in which the back tension of a spring is utilized and the internal-pressure of oil is not generated. A damper device is also known in which an inlet hole for injecting viscous fluid into a case is sealed at the bottom of the case by a bolt after the viscous fluid is injected. However, the damper device is further provided with a cover for preventing oil leakage.

### SUMMARY OF THE INVENTION

It is an advantage of the present invention to provide a rotary damper device capable of preventing problems due to using a conventional cover for preventing oil leakage.

In order to achieve the above advantage, according to the present invention, there is provided a rotary damper device including a case, a rotor member relatively rotatably supported by the case, a rotation vane formed protruded from the rotor member, and a check valve mounted on the rotation vane. The case is provided with an opened part on one side through which the rotor member is inserted into the inside of the case and a side wall part on the other side for rotatably supporting the rotor member. The opened part of the case is closed by a flange part that is integrally formed in the rotor member.

In accordance with an embodiment of the present invention, the case in which the rotor member is accommodated inside is provided with the side wall part on one side in the axial direction and the rotor member in itself is provided with the flange part on the other side. Therefore, two oil pressure receiving faces are formed by the case in itself and the rotor member in itself and thus a conventional oil leakage preventing cover is not necessary.

Preferably, a seal member is provided on the contacting face of the flange part of the rotor member with the case for assuring the seal of the opened part of the case.

Preferably, a pull-out stopper member is attached to the rotor member interposing the side wall part of the case to prevent the rotor member from pulling out the case easily. When the pull-out stopper member is constituted as a bearing member that serves as a bearing for the rotation shaft of the rotor member, the sliding friction of the rotor member is reduced and thus durability is improved. The pull-out stopper member can be easily attached to the rotation shaft of the rotor member by a screw, caulking, supersonic wave welding, a retaining snap ring or the like.

Preferably, the pull-out stopper member abuts the side surface of the side wall part of the case to assure the function as a pull-out stopper. The case and the rotor member are preferably formed of a metal die-casting to ensure strength.

In accordance with another embodiment of the present invention, there is provided a rotary damper device including a case, a rotor member relatively rotatably supported by the case, a rotation vane formed protruded from the rotor member, and a check valve mounted on the rotation vane. The case is provided at both ends with enlarged inner wall face parts that are respectively opened and formed in a larger diameter than a middle portion. A flange part of the rotor member and a bearing member are respectively fitted tightly to the enlarged inner wall face parts in a freely sliding manner at both ends of the case. Both of the side faces of the flange part and the bearing member are formed as oil pressure receiving faces in the rotor shaft direction.

In this constitution, the flange part of the rotor member and the bearing member are formed as oil pressure receiving faces in the axial direction. Therefore, a conventional oil leakage preventing cover is not used. Moreover, since the bearing member fixed to the rotor member is fixed to a rotation shaft of the rotor member, the bearing member can be firmly attached to the rotor member.

Preferably, the case and the rotor member are formed of a metal die-casting to ensure strength. Seal members are preferably used between the case and the rotor member and between the case and the bearing member to improve seal property.

### BRIEF DESCRIPTION OF THE DRAWINGS

FIGS. 1(a) and 1(b) show cross-sectional views of a damper device in accordance with a first embodiment of the present invention, wherein FIG. 1(a) shows a cross-sectional view along a rotation shaft and FIG. 1(b) shows a cross-sectional view taken on line B-B in FIG. 1(a).

FIG. 2 shows a cross-sectional view of a damper device along a rotation shaft in accordance with a second embodiment of the present invention.

FIG. 3 shows a cross-sectional view of a damper device along a rotation shaft in accordance with a third embodiment of the present invention.

FIG. 4 shows a cross-sectional view of a damper device along a rotation shaft in accordance with a fourth embodiment of the present invention.

FIG. 5 shows a cross-sectional view of a damper device along a rotation shaft in accordance with a fifth embodiment of the present invention.

FIGS. 6(a) and 6(b) show an operational explanatory view of a check valve in a braking state in the damper device of the present invention.

FIGS. 7(a) and 7(b) show an operational explanatory view of a check valve in a slipping state in the damper device of the present invention.

FIGS. 8(a) and 8(b) show an operational explanatory view in a conventional damper device.

### DETAILED DESCRIPTION OF THE PREFERRED EMBODIMENTS

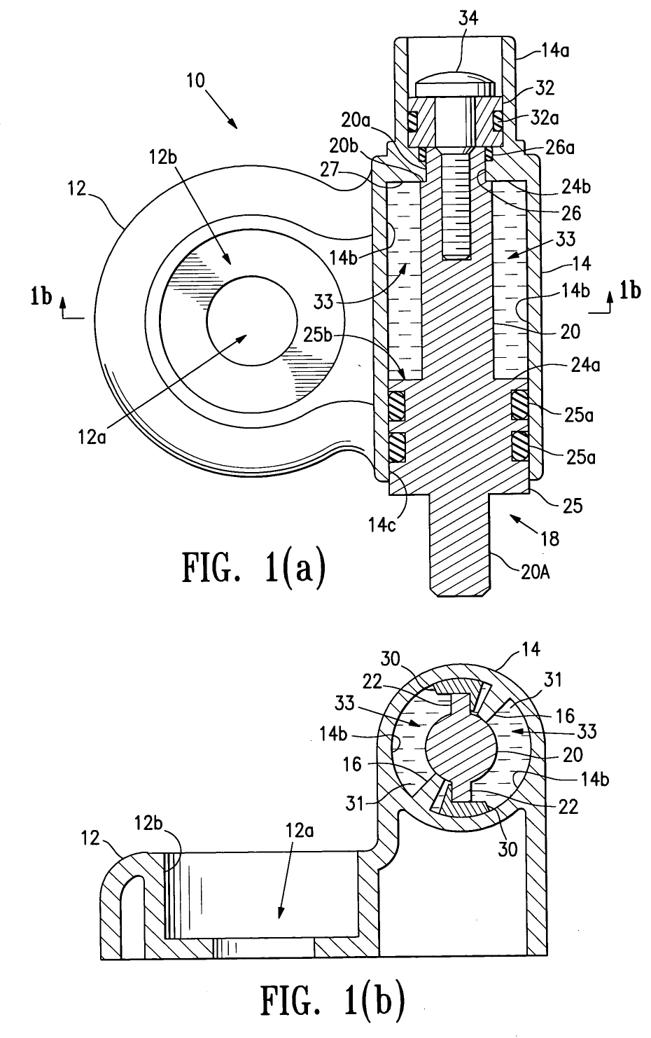

Damper devices in accordance with embodiments of the present invention are described below with reference to the accompanying drawings. FIGS. 1(a) and 1(b) show cross-sectional views of a damper device in accordance with a first embodiment of the present invention. FIG. 1(a) shows a cross-sectional view along a rotation shaft and FIG. 1(b) shows a cross-sectional view taken on line B-B in FIG. 1(a), which shows a general constitution of a check valve 30.

A damper device 10 in accordance with a first embodiment of the present invention is provided with a fixing portion 12 for fixing the damper device 10 to a Western style toilet stool that is not illustrated. The fixing portion 12 is integrally formed with a case 14. The fixing portion 12 is provided with a hole 12a for passing a bolt through and a counterbore hole 12b for accommodating the head part of the bolt. The case 14 is so constituted, as shown in FIG. 1(a), that one side (downside in the drawing) forms an opened part for allowing a rotation shaft 20 protruding outside. The external peripheral part on the other side (upside in the drawing) of the case 14 is formed as a fixed shaft part 14a, which is integrally formed with the case 14.

For the use in a toilet seat/seat lid, a pair of damper devices 10 are used at right and left positions in a Western style toilet stool. The viscosities of the oils used in the damper devices 10 are respectively changed to obtain different damping effects. For example, one of the damper devices 10 having less damping effect is mounted to a seat lid (not shown) in such a manner that the protruding part 20A of the rotation shaft 20 is fixed to the seat lid. A toilet seat (not shown) which has a larger weight than the seat lid is rotatably supported on the fixed shaft part 14a of the case 14. The other of the damper devices 10 having larger damping effect is mounted to the toilet seat in such a manner that the protruding part 20A of a rotation shaft 20 is fixed to the toilet seat. The lightweight seat lid is rotatably supported on the fixed shaft part 14a of the case 14 in the other damper device 10.

As shown in FIG. 1(b), two partition parts 16 are radially protruded toward a center direction in an axial symmetrical manner at two positions on the cylindrical inner wall surface 14b of the case 14. The tip end of the partition part 16 is formed in an arc face so as to fit loosely on the outer peripheral face of the rotation shaft 20, which constitutes a rotor member 18. Rotation vane parts 22 are formed on the rotor member 18 in an axial symmetrical manner so as to protrude from the rotation shaft 20 toward the cylindrical inner wall surface 14b. The tip end of the rotation vane part 22 is formed in an arc face along the cylindrical inner wall surface 14b. The rotation vane part 22 is constituted so as to be interposed by two oil pressure receiving faces 24a and 24b in an axial direction of the rotor member 18. The oil pressure receiving face 24a is the inner side face of a flange part 25 that is integrally formed in the rotation shaft 20 of the rotor member 18. Two O-rings 25a for sealing are dually attached on the outer peripheral face of the flange part 25 so as to press and come into contact with the cylindrical inner wall surface 14b of the case 14. The other oil pressure receiving face 24b is an inner side face formed by the case 14, that is, the inner side face of a side wall part 27 provided with a through-hole 26 for rotatably supporting the rotation shaft 20. An O-ring 26a for seal is attached on the inner peripheral part of the side wall part 27 in such a manner that the O-ring 26a tightly contacts with the rotation shaft 20.

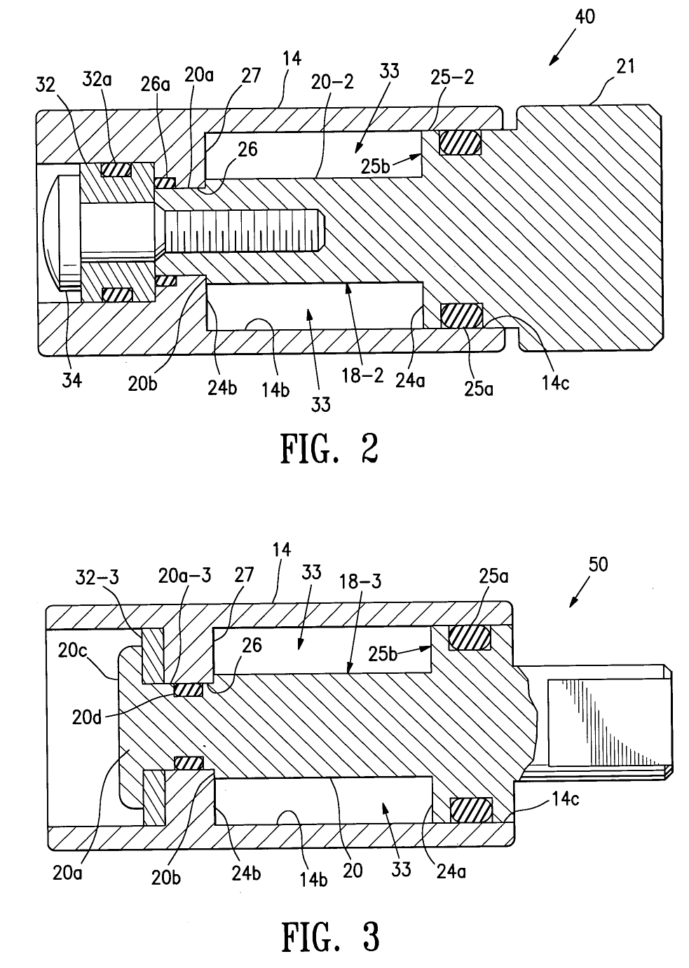

FIG. 2 shows a cross-sectional view of a damper device in accordance with a second embodiment of the present invention. The constitution and the operation of the fixing portion 12 and the check valve 30 are similar to those of the first embodiment shown in FIG. 1. The same numerical code in the drawing as in FIG. 1 refers to the same member as the first embodiment and its description is omitted. A damper device 40 in the second embodiment differs from the first embodiment in that a flange part 25-2 constitutes the rotor member 18-2, and other elements are similar to the first embodiment. In the first embodiment, two O-rings for sealing are used on the outer periphery of the flange part 25 in parallel so as to deal with oil of low viscosity, but only one O-ring for sealing is used as shown in the flange part 25-2 in the second embodiment.

In accordance with the damper device of the present invention, a conventional oil leakage preventing cover is not used due to the above described constitution. Therefore, an external connecting part 21 of the rotation shaft, which constitutes the rotor member 18-2, is not necessary to make a smaller diameter in order to attach the oil leakage preventing cover. In the damper device 40 of the second embodiment, the external connecting part 21 of the rotor member 18-2, which is integrally formed with the rotation shaft 20-2 together, can change its radial dimension and shape freely. In other words, the outside diameter of the external connecting part 21 can be formed larger than that of the casing 14.

FIG. 3 is a cross-sectional view of a damper device in accordance with a third embodiment of the present invention. A damper device 50 of the third embodiment is an example in which a screw member 34 mounting a bearing plate 32 to a rotor member 18-2 shown in FIG. 2 is replaced by a caulking part. The bearing plate 32 serves as a pull-out stopper member for the rotor member 18-2. A smaller diameter part 20a of the rotation shaft 20 passing through the through-hole 26 of the side wall part 27 is extended longer. An O-ring 20d is mounted around a smaller diameter part 20a-3 instead of an O-ring 26a mounted on the inner peripheral face of the side wall part 27.

A fitting portion of the smaller diameter part 20a-3 for a bearing plate 32-3 is formed in an elliptic or polygonal cross-sectional shape so that the bearing plate 32-3 rotates with the smaller diameter part 20a-3 together. The bearing plate 32-3 is formed in a thin disk shape and not provided with an O-ring 32a in FIG. 2. A fitting hole is provided in the bearing plate 32-3 to engage with the smaller diameter part 20a-3 in the circumferential direction so that the bearing plate 32-3 rotates with the smaller diameter part 20a-3 together. The protruded part of the smaller diameter part 20a-3 from the bearing plate 32-3 is plastically deformed to form a caulking part 20c. This caulking part 20c and the bearing plate 32-3 prevent a rotor member 18-3 from being pulled out the case 14. In this case, the bearing plate 32-3 serves as a pull-out stopper member for the rotor member 18-3. The operation and usage of the damper device 50 in the third embodiment are similar to those of the damper device 10 in the first embodiment.

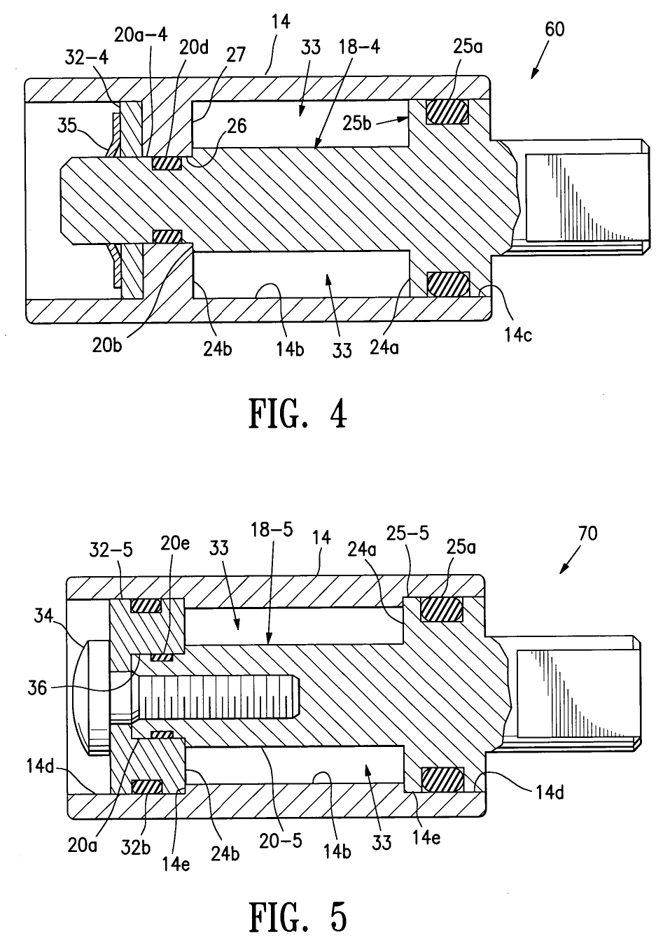

FIG. 4 shows a cross-sectional view of a damper device in accordance with a fourth embodiment of the present invention. The damper device 60 of the fourth embodiment uses a retaining snap ring 35 instead of the caulking part 20c in FIG. 3. The inner diameter portion of the retaining snap ring 35 is formed smaller than the outer diameter of a smaller diameter part 20a-4 of a rotation shaft. Therefore, the retaining snap ring 35 is pushed and fitted on the smaller diameter part 20a-4 from the left side and prevented from a backward movement because of its elastically deformed inner diameter portion. The structure of a bearing plate 32-4 and the smaller diameter part 20a-4 may be similar to those of the damper device 50 in the third embodiment.

FIG. 5 shows a cross sectional view of a damper device in accordance with a fifth embodiment of the present invention. The damper device 70 of the fifth embodiment is an example which is not provided with the side wall part 27 of the case 14. The case 14 is provided at both ends with enlarged inner wall face parts 14d which are respectively formed opened parts in a larger diameter than the middle portion of the case 14. A flange part 25-5 of a rotor member 18-5 and a bearing plate 32-5 are respectively fitted to the enlarged inner wall face parts 14d in a freely sliding manner at both ends of the case 14. An O-ring 25a is mounted around the flange part 25-5 of a rotor member 18-5 and an O-ring 32b is mounted around the bearing plate 32-5. The opposing side faces of the flange part 25-5 and the bearing plate 32-5 are formed as oil pressure receiving faces 24a and 24b in the rotation shaft direction.

A smaller diameter part 20a-5 is formed at the left end side of a rotation shaft 20-5 of a rotor member 18-5 and the bearing plate 32-5 having a fitting hole 36 is fitted to the end portion of the smaller diameter part 20a-5. The fitting hole 36 of the bearing plate 32-5 is concavely formed with a depth of greater than half of the thickness of the bearing plate 32-5 in the axial direction. The smaller diameter part 20a-5 of the rotation shaft 20-5 is fitted into the fitting hole 36 and the outer peripheral face of the smaller diameter part 20a-5 is sealed with an O-ring 20e The bearing plate 32-5 is fixed to the rotation shaft 20-5 with a screw member 34 to rotate in an internal manner. The screw member 34 is preferably locked by an adhesive agent or the like. The bearing plate 32-5 and the flange part 25-5 are respectively abutted against enlarged step parts 14e provided on both sides of the case 14 in a sliding manner in a circumferential direction and the movement of the rotor member 18-5 is restricted in the axial direction. The bearing plate 32-5 and the flange part 25-5 respectively form the oil pressure receiving faces 24a and 24b.

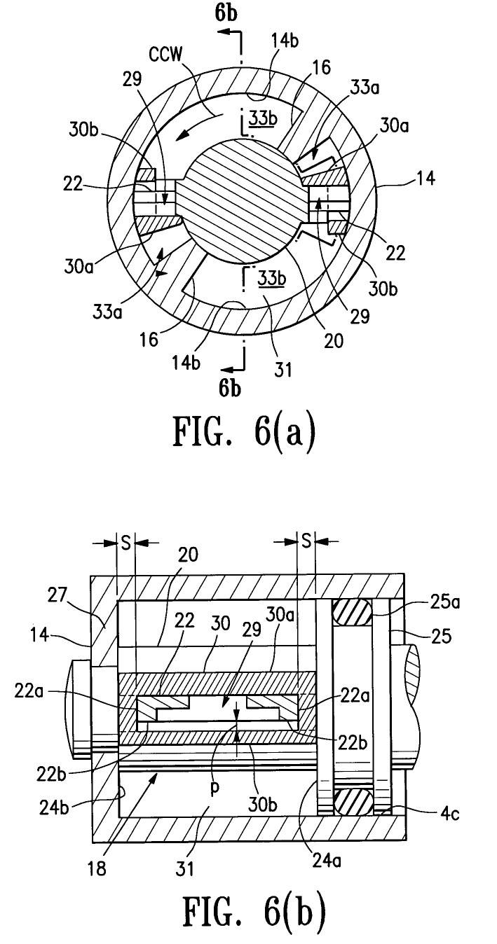

Next, the operation of the damper device of the present embodiment is described below with the reference to FIGS. 6(a) and 6(b). In FIG. 6, both side faces 22a on the tip side of each rotation vane 22 in the axial direction are opposed to the oil pressure receiving faces 24a and 24b with a gap “s”. The thickness of each rotation vane 22 in a rotational direction is set in such a manner that the central part is formed thinner than the protruded part 22b formed at both sides in the axial direction. A cutout part 29 with a prescribed axial length and depth is formed as an orifice in the central part where its thickness is made thinner.

The check valve 30 is a rectangular tube body which is interposed in the gap “s” between the side faces 22a of the rotation vane 22 and the oil pressure receiving faces 24a and 24b so as to surround the rotation vane 22. The outer tip end surface, which slides with the cylindrical inner wall surface 14b, is formed in a circular face. The check valve 30 is provided with a closing part 30a that is capable of closing the entire cutout part 29 (orifice) formed in the rotation vane 22. The check valve 30 is also provided with a connecting part 30b which is formed so as to connect both sides of the closing part 30a in the axial direction on the opposite side across the rotation vane 22. When the rotation vane 22 is rotated in the CCW direction in FIG. 6(a), the closing part 30a closes the entire cutout part 29 (orifice) of the rotation vane 22 to perform a damper function. The connecting part 30b is formed about half the radial length from the base portion to the outer tip end of the rotation vane 22. The dosing part 30a and the connecting part 30b of the check valve 30 are fitted to the rotation vane 22 so as to have a gap “p” in the rotational direction. Thus the check valve 30 is supported by the rotation vane 22 so as to be able to move within the gap “p” along the cylindrical inner wall surface 14b.

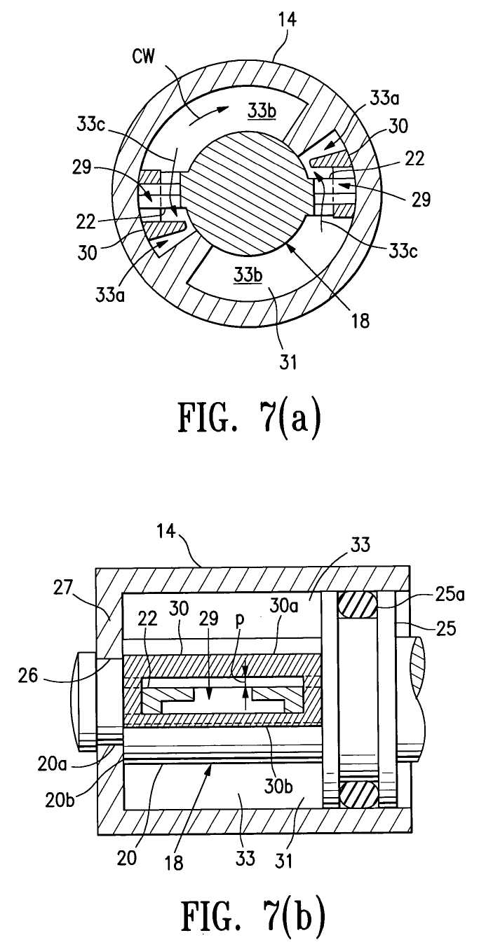

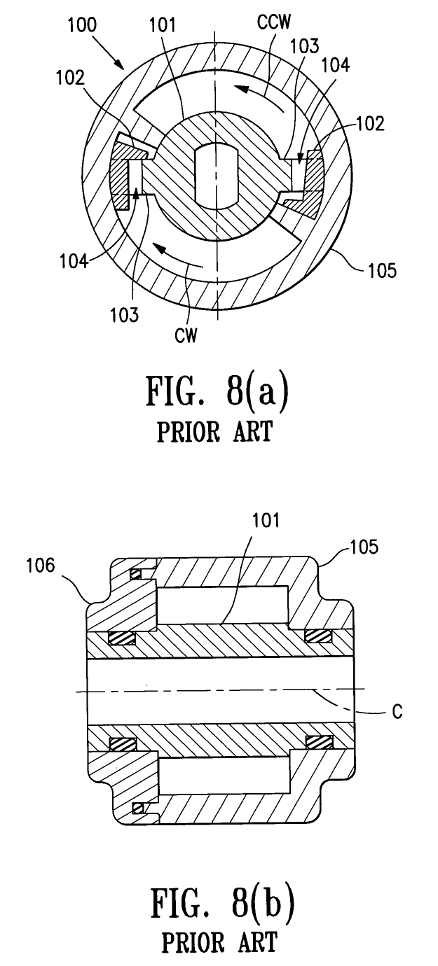

Next, the assembling method of the damper device 10 is described below with the reference to FIGS. 7(a) and 7(b). In FIG. 7(a), a specified amount of silicone oil 31 (hereinafter, referred to as oil) is filled in the case 14. Then, the check valve 30 is mounted on the rotation vane 22 and the rotor member 18 having the flange part 25, on which the O-ring 25a is attached on the outer peripheral face, is inserted into the case 14. The tip end of the smaller diameter part 20a of the rotation shaft 20 is inserted through the through-hole 26 of the side wall part 27 of the case 14. And then a smaller diameter step part 20b of the rotation vane 22 is positioned to be close to the inner surface of the side wall part 27 in a sliding state in the rotational direction.

In the case of the embodiment in FIG. 2, the O-ring 26a is mounted on the through-hole 26 of the side wall part 27 of the case 14 from the side opposite to the inserting direction of the rotor member 18-2. Then, the bearing plate 32 mounting the O-ring 32a on its outer periphery is inserted into the case 14, fastened to the rotation shaft 20-2 with a screw member 34 such as a bolt, and locked by using adhesive such as a screw lock agent. The O-ring 25a is fitted around the flange part 25-2, which is formed integrally with the rotor member 18-2 so as to contact sidably with the opened part, that is, the cylindrical inner wall surface 14c of the case 14. The flange part 25-2 is positioned on the outer side from the partition part 16 projected from the cylindrical inner wall surface 14b of the case 14 in the axial direction. The inner side surface 25b of the flange part 25-2 is sidably in contact with the side surface of the partition part 16. The rotation shaft 20-2 and the bearing plate 32 are constituted as one body and the rotor member 18-2 is supported by the case 14 to be rotated relatively.

In FIGS. 6 and 7, the silicone oil 31 is filled inside the case 14 and sealed up between the oil pressure receiving face 24a of the flange part 25 and the oil pressure receiving face 24b of the side wall part 27 in the direction of the rotor shaft. It is important that the oil pressure receiving face 24a is formed by the flange part 25 formed integrally with the rotor member 18 and the oil pressure receiving face 24b is formed by the side wall part 27 formed integrally with the case 14. Two partial cylindrical rooms 33, which are arcuately formed between the two partition parts 16 of the case 14, are respectively divided into an oil chamber 33a and an oil chamber 33b by the rotation vane 22. When the check valve 30 is fitted to the rotation vane 22, a simple stopper member such as a snap fitting is preferably used to prevent the check valve 30 from falling off the rotation vane 22 to improve assembling workability. By the above-mentioned constitution, an oil leakage preventing cover is not necessary in the damper device of the present invention.

Next, the operation of the damper device according to the present invention is described below. FIGS. 6(a) and 6(b) show an operational explanatory view of the check valve 30 in a braking state, when the rotation vane 22 moves in the working direction (CCW direction in the drawing) of the damper function. FIGS. 7(a) and 7(b) show an operational explanatory view of the check valve 30 in a slipping state, when the rotation vane 22 moves in the slipping direction (CW direction in the drawing) so that the damper function is not operated. FIGS. 6(a) and 7(a) each shows a cross-sectional view perpendicular to the rotation shaft, and FIGS. 6(b) and 7(b) each shows a cross-sectional view along the rotation shaft.

In FIGS. 6(a) and 6(b), when the rotation shaft 20 is rotated in the counter-clockwise direction CCW with respect to the case 14, the oil in the oil chamber 33a is pressurized and tries to move to the oil chamber 33b. Thus, the check valve 30 is tightly in contact with the rotation vane 22 by the oil pressure and closes the cutout part 29 of the rotation vane 22. Accordingly, the oil 31 moves only through the gaps between the inner wall face of the case 14 and the rotation shaft 20, the rotation vane 22, the check valve 30 or the like. The oil resistance in this state gives a braking force and thus a toilet seat/seat lid can be closed slowly.

In FIGS. 7(a) and 7(b), when the rotation shaft 20 is rotated in the clockwise direction CW with respect to the case 14, the oil in the oil chamber 33b is pressurized and tries to move to the oil chamber 33a. At this time, the check valve 30, for example, at a position shown in FIGS. 6(a) and 6(b) moved by the gap “p” to open the cutout part 29 by the oil pressure. Accordingly, as shown in FIG. 7(a), the gap “p” between the rotation vane 22 and the check valve 30 and the cutout part 29 form an oil passage 33c. The oil 31 can easily move from the oil chamber 33b to the oil chamber 33a through the oil passage 33c when the rotation shaft 20 is rotated in the clockwise direction. Therefore, since a large oil resistance is not generated, the rotation shaft 20 is rotated easily and the toilet seat/seat lid can be opened with little force.

The embodiments of the present invention are described above. However, needless to say, the present invention is not limited to the embodiments described above, and many modifications can be made without departing from the subject matter of the present invention.

For example, the damper device according to the present invention can be effectively used not only in a toilet seat/seat lid but also in a moving body such as a door closer or the lid of a trash box, which is connected by a hinge to swing lightly in one direction and slowly in the opposite direction.

As described above, the rotary damper device according to the present invention is not needed to use a conventional oil leakage preventing cover. Accordingly, necessary parts are reduced, assembling of the device becomes easy and cost can be reduced. Unexpected expansion of the oil passage within the case by the internal-pressure of oil can be reduced. Further, the shaft part of the rotor member can be formed larger than the case and thus a wide range of applications can be obtained.

While the description above refers to particular embodiments of the present invention, it will be understood that many modifications may be made without departing from the spirit thereof. The accompanying claims are intended to cover such modifications as would fall within the true scope and spirit of the present invention.

The disclosed embodiments are therefore to be considered in all respects as illustrative and not restrictive. The scope of the invention being indicated by the appended claims, rather than the foregoing description, and all changes which come within the meaning and range of equivalency of the claims are therefore intended to be embraced therein.

What is claimed is:

1. A rotary damper device comprises:
a case;
a rotor member relatively rotatably supported by the case;
a rotation vane formed protruded from the rotor member; and
a check valve mounted on the rotation vane,
wherein the case is provided with an opened part on one side through which the rotor member is inserted into the inside of the case and a side wall part on the other side for rotatably supporting the rotor member,
the opened part of the case is closed by a flange part that is integrally formed in the rotor member, and
the side wall part includes a pressure receiving face and the flange part includes another pressure receiving face.

2. The rotary damper device according to claim 1, wherein a seal member is provided between the flange part of the rotor member and the opened part of the case for sealing the opened part of the case.

3. The rotary damper device according to claim 1, wherein a pull-out stopper member for the rotor member from the case is mounted to the rotor member so as to interpose the side wall part of the case.

4. The rotary damper device according to claim 3, wherein the pull-out stopper member includes a bearing portion serving as a bearing for the rotor member.

5. The rotary damper device according to claim 3, wherein the pull-out stopper member is mounted to the rotor member selected from the group consisting of a screw member, a caulking, a supersonic wave welding and a retaining snap ring.

6. The rotary damper device according to claim 3, wherein the pull-out stopper member abuts the side surface of the side wall part of the case.

7. The rotary damper device according to claim 1, wherein the case and the rotor member are formed of a metal die-casting material.

8. A rotary damper device comprises:
a case;
a rotor member relatively rotatably supported by the case;
a rotation vane formed protruded from the rotor member;
a check valve mounted on the rotation vane; and
a bearing member mounted to the rotor member,
wherein the case is provided at both ends with enlarged inner wall face parts which are respectively opened and formed in a larger diameter than a middle portion,
a flange part of the rotor member and the bearing member are respectively fitted to the enlarged inner wall face parts in a freely sliding manner, and
both of the side faces of the flange part and the bearing member are formed as oil pressure receiving faces.

9. The rotary damper device according to claim 8, wherein the case and the rotor member are formed of a metal die-casting material.

10. The rotary damper device according to claim 8, wherein the case is preferably sealed by a seal member with the rotor member and bearing member.

11. The rotary damper device according to claim 1, wherein the rotation vane is formed on the rotor member is an axial symmetrical manner.

12. The rotary damper device according to claim 1, wherein the rotation vain is interposed by the pressure receiving faces.

13. The rotary damper device according to claim 4, wherein a fitting portion of a small diameter part of the bearing portion is formed in a shape selected from the group consisting of an elliptic and a polygonal cross-selectional shape.

14. The rotary damper device according to claim 4, wherein the bearing portion is formed in a thin disk shape.

15. The rotary damper device according to claim 13, wherein a fitting member is provided in the bearing portion to engage the small diameter part so that the bearing portion rotates with the small diameter part.

16. The rotary damper device according to claim 4, wherein a sealing member is mounted around the bearing portion.

17. The rotary damper device according to claim 8, wherein a fitting portion of a small diameter part of the bearing member is formed in a shape selected from the group consisting of an elliptic and a polygonal cross-sectional shape.

18. The rotary damper device according to claim 8, wherein the bearing member is formed in a thin disk shape.

19. The rotary damper device according to claim 17, wherein a fitting member is provided in the bearing member to engage the small diameter part so that the bearing member rotates with the small diameter part.

20. The rotary damper device according to claim 8, wherein a sealing member is mounted around the bearing portion.
